(19) United States
(12) Patent Application Publication
(10) Pub. No.: US 2006/0121980 A1
(43) Pub. Date: Jun. 8, 2006

(54) Method and system for using preprinted coupons in a multiuser game

(76) Inventors: Hannu Heilala, Vantaa (FI); Markku Koresaar, Vantaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 11/004,159

(22) Filed: Dec. 3, 2004

(51) Int. Cl. G06F 17/00; G06F 19/00

(52) U.S. Cl. 463/25

(57) ABSTRACT

Preprinted coupons (213, 701, 901, 1001) are used in a game. A coupon identifier is read (1401) from a coupon (213, 701, 901, 1001) that also contains a preprinted gaming row. On the basis of the coupon identifier, a gaming system (1106) is informed (1402, 1510) about the playing of the gaming row. The contents of the gaming row are derived (1508, 1509) from the coupon identifier read from the coupon (213, 701, 901, 1001) by using at least a part of the coupon identifier as input information to a random permutator (401) that maps input information to a list of possible gaming rows.

### TECHNICAL FIELD

The invention concerns generally the technology of preparing preprinted coupons for use in a multiuser game, and handling such coupons during the game. Especially the invention concerns the problem of how to simplify the requirements for distributed hardware in a widespread system that allows using preprinted coupons for playing. The definition “multiuser” means here that the potential number of players is very large, for example of the order of the whole population of a city or a country.

### BACKGROUND OF THE INVENTION

Games of chance that are played among very large numbers of people and throughout wide geographical areas are practically all derivatives from the basic idea known widely as Lotto: The players have a certain time, during which they must file the coupons on which they have made their guess about a row of N correct symbols out of a space of M possible symbols, where N<M. After a closing time, after which coupons are not accepted any more, the game organiser uses a random process to draw the correct row of N symbols. Each player is later credited according to how many symbols he or she had guessed right. Betting and multiuser sports games like Tote can be considered as games of chance for the purposes of this patent application, even if the player may have better possibilities of winning by obtaining sufficient knowledge about the capabilities of the competing entities, since despite of some dependency on initial conditions, betting inevitably involves also a great deal of luck. A sports game is a multiuser game where players try to predict the outcomes of sports events with a required degree of accuracy that depends on the game. For example, one must simply predict the winner, or the winner and the runner-up, or the winners of a number of separate races, or the final score of one or more games and so on.

Originally each player received an empty coupon, on which he marked his guessed row for example by ticking in preprinted number boxes. An optical reading device was used to read the coupons into electronic form, which facilitated easy checking of the distribution of the players' profit shares. In order to collect his earnings a lucky player had to later visit the game organiser's office or an agent, where he produced his original coupon or a receipt copy thereof for annulling and received his prize. As an alternative, a player could write his name, address and account number to the coupon, so that the game organiser could send prizes by mail or pay them directly to the players' accounts.

Preprinted coupons have also been known for a very long time. The idea of preprinted coupons is in its simplest form that since—despite of many players' superstitious beliefs about their own “lucky numbers”—every row has exactly the same probability of winning, the player does not need to tick the boxes himself but can just pick a coupon containing a preprinted row of N randomly selected symbols. In the most straightforward arrangement a preprinted coupon has the same outline as a manually filled coupon, and the same optical reading device is used to read its contents to the electronic data processing system.

A kind of alternative to using preprinted coupons is the use of dedicated gaming terminals, which can generate a required number of rows in an online state and print a receipt to the player, containing the generated row(s) and a security code produced with a secret algorithm in order to prevent dishonest players from producing counterfeit receips after the correct numbers were known.

A disadvantage related to both traditional preprinted coupons and online gaming terminals is the relative complicatedness of distributed hardware. If the game is meant for a very large number of people living on a very wide geographical area, there must be a significant number of offices or agents deployed that possess the required optical reading devices and/or gaming terminals. These offices or agents and their hardware may be characterised as being located in a distributed domain, contrary to the game organiser's system that is located in a centralised domain. Introducing a new game or making variations to old ones is slow, because all hardware in the distributed domain must be updated before any changes may be taken into use. Additionally the coupons must usually follow a strictly standardised format in order to be legible for the optical reading device, which limits the freedom of e.g. combining the games with other products such as newspapers, magazines, food casings and the like.

FIG. 1 illustrates a known further developed version of playing with preprinted coupons. As a first step, there is generated a database 101 containing a large number of randomly generated rows and their unique identifiers, here represented as AA1, AA2 and AA3. Typically the rows are generated first with a random number generator, and a completed row or group of rows are then numbered in consecutive order, so that the current running number becomes the identifier of the current row or group of rows. As a second step a batch 102 of preprinted coupons is printed, so that each coupon contains one or more rows and their unique identifiers. In order to facilitate easy automatic reading it is advantageous to print the unique identifiers to the coupons in machine readable form, such as a bar code. As a third step a player picks a single coupon 103, which the selling agents activates by reading the identifier with an electronic reading device 104. Information about the read identifier goes to the central computer system 105 of the game organiser, which also has access to the original database 101 that links together the identifiers and rows. Thus the game organiser knows, which of the preprinted rows have been played.

The disadvantage of the solution illustrated in FIG. 1 is the need for a large centralised database 101. The number of possible rows in a widespread game of chance is easily in the order of hundreds of millions, which means that the volume of the database becomes easily very large. A large collection of digital data is always prone to errors, which must be accounted for by making duplicate or triplicate copies, which eats up even more storage space.

### SUMMARY OF THE INVENTION

It is an objective of the invention to present a method and a system for using preprinted coupons in a game of chance without having to establish and maintain large centralised databases, and not needing complicated distributed hardware. An additional objective of the invention is to allow combining multiple types of games under the same method and system.

The objectives of the invention are met by establishing a relationship between a coupon identifier and at least one row that can be played with the coupon, so that it becomes possible to also later generate the correct row(s) from the identifier alone.

According to an aspect of the invention a method for using preprinted coupons in a game comprises:

reading a coupon identifier from a coupon that also contains a preprinted gaming row,

on the basis of the coupon identifier, informing a gaming system about the playing of the gaming row, and

deriving the contents of the gaming row from the coupon identifier read from the coupon by using at least a part of the coupon identifier as input information to a random permutator that maps input information to a list of possible gaming rows.

According to another aspect of the invention a system for using preprinted coupons in a game comprises an electronic terminal and a gaming computer, of which

the electronic terminal is adapted to receive a coupon identifier of a preprinted coupon and to communicate the coupon identifier to the gaming computer, and

the gaming computer is adapted to store information about the playing of a gaming row on the basis of the coupon identifier received from the electronic terminal;

wherein the gaming computer is adapted to derive the contents of the gaming row from the coupon identifier by using at least a part of the coupon identifier as input information to a random permutator that maps input information to a list of possible gaming rows.

By employing a suitable mathematical relationship it is possible to use a coupon identifier as a so-called seed, from which it is possible to unambiguously arrive at a certain row or a group of rows without any previous knowledge about that row or those rows, if one only knows said mathematical relationship. It is additionally possible to construct said mathematical relationship so that without knowing it, even knowing any number of ascertained identifier-row pairs it is not possible to deduce, which row will result from some other identifier.

According to the invention, both the party that produces the preprinted coupons and the agent that activates selected coupons for playing (or, in fact, the data processing devices used by said party and said agent) are aware of said mathematical relationship. At the coupon production stage, from each coupon identifier the corresponding row(s) is/are derived and printed on a coupon together with the identifier. However, the one-to-one or one-to-group relationship between identifier and row(s) does not need to be stored. When a selling agent wants to activate a row, i.e. mark it as bought, he uses an automatic reading device to read the identifier. The selling terminal sends the read identifier to the game organiser's system, which uses said mathematical relationship to derive therefrom the row(s) that was/were thus played. Alternatively the derivation of the row(s) may be accomplished already at the selling terminal, so that the selling terminal can directly announce the played row(s) to the game organiser's system.

According to an embodiment of the invention it is possible to combine different games in preprinted coupons. For the preprinted rows of each game there may be a separate game-specific identifier on the coupon. By using suitably parallel mathematical algorithms it is even possible to use only a single coupon-specific identifier on the coupon, from which the rows of the different games can be derived by using said parallel mathematical algorithms as different ways of interpreting the information encoded in the identifier. Also combinations of game-specific and coupon-specific identifiers are possible.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

### BRIEF DESCRIPTION OF DRAWINGS

FIG. 1 illustrates a prior art method for using preprinted coupons,

FIG. 2 illustrates a method according to an embodiment of the invention,

FIG. 3 illustrates a method according to another embodiment of the invention,

FIG. 4 illustrates using random permutation for generating rows from identifiers,

FIG. 5 illustrates a batch of coupons obtained with the method of FIG. 4,

FIG. 6 illustrates using two concatenated random permutations,

FIG. 7 illustrates a coupon with multiple gaming rows,

FIG. 8 illustrates using random permutation and ordered numbers for generating multipla rows from an identifier,

FIG. 9 illustrates a coupon with multiple games and game-specific identifiers,

FIG. 10 illustrates a multigame coupon with multiple games and a single identifier,

FIG. 11 illustrates a system according to an embodiment of the invention,

FIG. 12 illustrates a method implemented in a game generator computer,

FIG. 13 illustrates a method implemented in a printing controlling computer,

FIG. 14 illustrates a method implemented in an electronic cash terminal and

FIG. 15 illustrates a method implemented in a gaming computer.

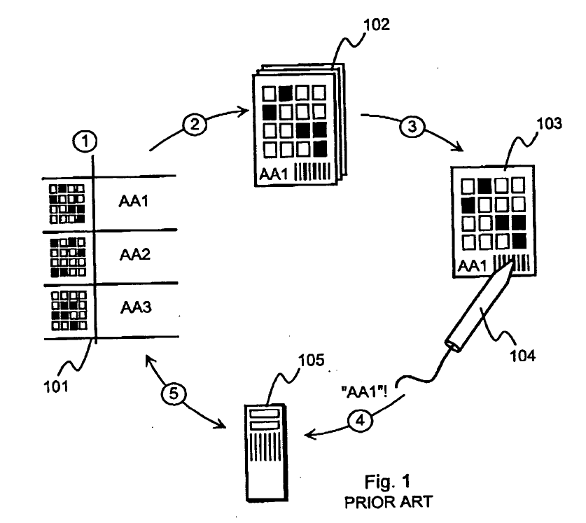

### DETAILED DESCRIPTION OF THE INVENTION

In the following we first assume that there exists a so-called unidirectional algorithm, which accepts a piece of input information in specified form and produces a piece of output information in specified form. We also assume, for the time being, that said unidirectional algorithm is mathematically a bijection, which means that there is a one-to-one relationship between its input and output: for each piece of allowable input information exactly one piece of output information will result, and for each piece of produced output information there will be exactly one piece of input information that resulted in producing just that output. Later we will relax some of these requirements, and also discuss in more detail certain actual algorithms that can be used. Unidirectionality is taken to mean that from a given piece of output information only it is not possible to deduce, what was the corresponding piece of input information; in many cases it is also advantageous that even knowing one certain input-output pair does not help in guessing, what output will result from some other known input or what input produced some other known output.

In the practical framework of the present invention a “piece of input information” is the same as a coupon identifier or a predefined part thereof, and a “piece of output information” is a gaming row or a group of several gaming rows.

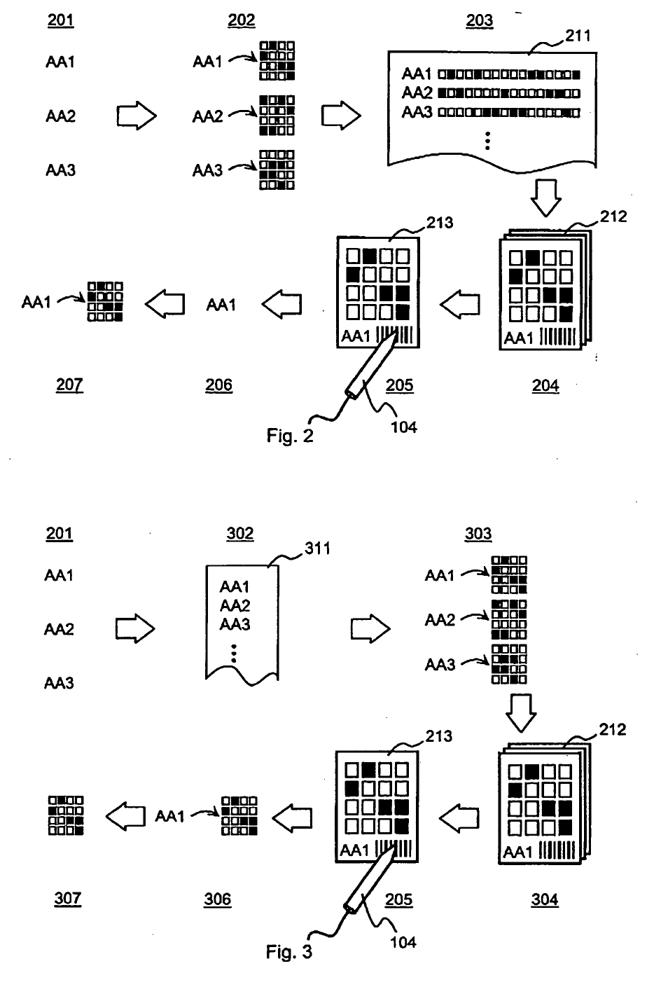

FIG. 2 illustrates a series of events that take place during a game of chance played with preprinted coupons. At step 201, there are generated a large number of coupon identifiers—only three of them are shown in the drawing, although a person skilled in the art will understand that the total number of identifiers may be in the order of millions. At step 202 a unidirectional algorithm of the kind described above is used to generate a unique gaming row from each coupon identifier. At step 203 the coupon identifiers and their associated gaming rows are all written to a file 211; typically the identifiers and gaming rows both consist of alphanumerical characters, so the file 211 may well be a text file.

At step 204 the file 211 has been taken to a printing house, which uses it to print a batch 212 of preprinted coupons. On each coupon there is printed a unique coupon identifier and the associated unique gaming row. In FIG. 2 we assume that the coupon identifiers exist on the coupons both in a cleartext form and in a machine-readable form, but this is not an absolute requirement. The batch 212 of preprinted coupons is distributed to selling agents. At step 205 a selling agent sells one preprinted coupon 213. In association with the selling event the selling agent uses an automatic reading device 104 coupled to an electronic cash terminal to read the identifier of the sold coupon. Additionally or alternatively the selling agent could read the cleartext form of the coupon identifier and key it in using a keypad of said electronic cash terminal.

At step 206 the electronic cash terminal announces the read identifier to the game organiser's system. There, at step 207, the unidirectional algorithm is again used to regenerate the row that appeared on the sold coupon 213, which row is subsequently marked as played. If the player gave some identification information of himself or herself to the selling agent, such identification information could be conveyed to the game organiser's system together with the coupon identifier at step 207 and stored in association with the regenerated row at step 207. As a result, the game organiser's system is fully aware of all played rows, without ever having to consult any database that would relate the coupon identifiers and their associated gaming rows together.

FIG. 3 illustrates a slightly different way of arriving at the same result. The step 201 of generating the coupon identifiers is the same as in FIG. 2. However, instead of generating the gaming rows at this point, only the coupon identifiers are written into a file 311 at step 302 and taken to the printing house. A computer that controls the printing machine (or a preprocessing computer linked to such a controlling computer at the printing house) uses each coupon identifier and said mathematical algorithm to produce the gaming rows at step 303, which apart from the different execution environment is thus essentially the same as step 202 in the method of FIG. 2. Since the generation of gaming rows is now intimately connected with the step of printing the batch 212 of preprinted coupons, also the last-mentioned step is now separately designated as step 304. The resulting preprinted coupons are exactly the same, independently of whether the generation of gaming rows took place at the game organiser's premises or at the printing house.

The step 205 of selling a coupon and reading its identifier is the same as in FIG. 2. However, at step 306 the electronic cash terminal of the selling agent already uses the mathematical algorithm to regenerate the appropriate gaming row from the identifier it read from the sold coupon. This time the played row and not the coupon identifier is communicated to the game organiser's system, which only stores the played row at step 307. The same considerations as above about possibly also conveying and storing identification information about the player apply here.

The step of communicating either the coupon identifier (as in FIG. 2) or the gaming row(s) (as in FIG. 3) does not need to take place immediately at the moment when the coupon identifier is read, even if the game may well include a feature according to which all stakes must be placed or all desired rows played before a certain closing moment. It suffices if a record that will be produced as a result of reading the coupon identifier comes to contain a reliable time stamp indicating the moment it was generated, so that later when information is communicated to the game organiser's system, it can check the time stamp and only accept such gaming rows as played for which the time stamp indicates that the coupon identifier was read before the closing moment.

Cross combinations of the embodiments shown in FIGS. 2 and 3 are possible. For example, even if the generation of gaming rows took place at the printing house as in step 303 of FIG. 3, the electronic cash terminal may only communicate the read coupon identifier to the game organiser's system as in step 206 of FIG. 2. Vice versa, even if the file 211 given to the printing house already contained also the gaming rows as in step 203 of FIG. 2, the elecronic cash terminal may still be intelligent enough to readily convert the read identifier into a regenerated gaming row as in step 306 of FIG. 3. There may even be two kinds of electronic cash terminals around, so that some of them convey only coupon identifiers to the game organiser's system while others convey complete regenerated rows. In such a case it is naturally on the responsibility of the game organiser's system to regenerate the gaming rows corresponding to the coupon identifiers received from electronic cash terminals of the first-mentioned type.

The methods of FIGS. 2 and 3 involve many advantages. There is no need for any centralised database that would link together the coupon identifiers and the corresponding rows. Unlimited freedom is given for designing the outer appearance of what has been conventionally designated as “coupons”: an exemplary and non-limiting list includes printing the gaming rows and coupon identifiers to the back of cereal packages, distributing them electronically as character strings or digital images, or casting them into the shape of business gifts made of plastic. Only the coupon identifier must remain readable in some form. In FIGS. 2 and 3 a bar code has been illustrated as an exemplary machine-readable code, but this does not exclude using other kinds of machine-readable codes, including but not being limited to magnetic strip codes, standard-form character strings, RFID (Radio Frequency IDentifier) type codes and the like. Distiributing the “coupons” to players may well take place in advance and free of charge, if playing the game subsequently requires the players to come to a selling agent to “activate” or “validate” their coupons.

Even more variety can be brought to the concept of a “coupon” by noting that a “coupon” does not need to be reduced into tangible form at any stage of the process of gaming. A “coupon” may be an electronic record which is produced in an electronic system, displayed to a player on a display screen and only handled in digital form in the memories of computer systems. In such systems it is even possible to allow the player to input the address or coupon identifier from which a computer system then generates the gaming row(s). An acceptance stage may follow in which the player accepts the generated row(s).

We may now discuss the features of possible mathematical algorithms in more detail. As such, the choice of an algorithm is not important to the general idea of using coupon identifiers as the primary way of identifying rows and actually regenerating said rows from the coupon identifiers only according to need. However, important additional advantages may be gained by selecting a proper algorithm.

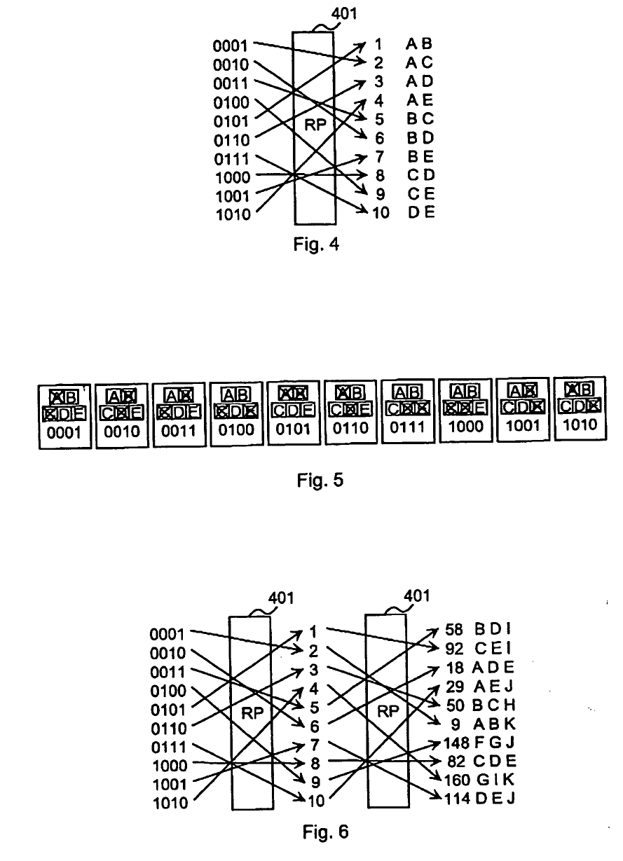

FIG. 4 is associated with an overly simplified game of chance, in which the player must guess two out of five possible symbols A, B, C, D and E. There are ten possible gaming rows, as illustrated in the right-hand column. Using a systematic way of constructing all possible rows produces them in a well defined order: first and second symbol (A B), first and third symbol (A C), first and fourth symbol (A D), first and fifth symbol (A E), second and third symbol (B C), and so on. We may thus assume that each possible row has a simple ordinal number: for example, row number 3 is “A D”. This particular systematic way of constructing all possible rows may be generally described in the case of selecting N symbols n, . . . n_{N} out of a space of M possible symbols m₁. . . m_{M} as follows:

a) Construct the first row by taking n₁=m₁, n₂=m₂ and so on until n_{N}=m_{N}.

b) Construct the second, third, . . . ,(M-N+1)th row by keeping the N−1 first symbols as they are but scrolling the last symbol through the remaining unused part of the symbol space: n_{N}=m_{N+1}, n_{N}=m_{N+2} and so on until n_{N}=m_{M}.

c) Construct the (M-N+2)th row by keeping the N−2 first symbols as they are but incrementing the indices of the two last symbols: n_{N-1}=m_{N}, n_{N}=m_{N+1}.

d) Repeat steps b) and c) until the second last symbol has scrolled through the remaining symbol space, and for each occurrence of a second last symbol the last symbol has scrolled through the remaining symbol space.

e) Repeat changing always the last symbol that has not yet been scrolled through all remaining symbol space until all rows have been constructed.

The systematic generating principle can be generalised to cases with arbitrarily large numbers of possible rows. Since the generation of rows takes place systematically, it is even possible to present a mathematical formula from which any m:th row can be unambiguously generated, where m is between one and the number M of all possible rows, without having to first generate the list of rows from the 1st row to the m−1:th row.

Generating a random permutation is a task that has been extensively studied in computer science, and a large number of commercially available randon permutator programs exist, for example as parts of the well-known Mathematica and Matlab mathematical computer program packages. “Mathematica” is a registered trademark of Wolfram Research Inc. and “Matlab” is a registered trademark of The MathWorks Inc. Basically a random permutator returns a set of given input symbols in an order which appears to be completely accidental. In practice, a computer-executed algorithm always operates in a very causal and predictable manner, so that if the random permutator is identically initialised at two different occasions, it will return an identical output set in both cases.

On the left in FIG. 4 we have a sequence of addresses, which have been given as binary numbers in order not to confuse them with the ordinal numbers of the rows. We assume that there exists a random permutator function RP, the syntax of which is
RP(address, set_size, seed)=ordinal number

In other words, when an address is given to the RP function, an ordinal number of a gaming row results, taken between 1 and set_size, that on the face of it does not have any dependency on what was the original address. In practice the same ordinal number always results for that address if the seed stays the same. For example,
RP(0110, 10, seed)=3
where we assume that some known seed was used. From a system point of view a random permutator behaves like a hardware component, taking addresses (and set size and seed parameters) as inputs and giving ordinal numbers as outputs. This component nature of the RP random permutator has been emphasized in FIG. 4 by illustrating it as a system component block 401.

Since the RP function is a random permutator, if we take in turn all possible addresses between 1 and set_size and keep the seed constant, as a result we get each ordinal number between 1 and set_size exactly once, but in random order.

We may select the binary addresses at the left of FIG. 4 as coupon identifiers, resulting in the preprinted coupons illustrated in FIG. 5. The basic requirements listed at the beginning of the detailed description of the invention are fulfilled: the process of mapping coupon identifiers to rows is a bijection, and from a given pair of coupon identifier and row it is not possible to deduce the correspondence of any other coupon identifier and row.

Taken that the number of possible gaming rows in a game of chance may be hundreds of millions, it may easily happen that giving a unique identifier to them all would require the identifier to be a very long character string. In many cases a limitation can be made, according to which the rows printed on the preprinted coupons of a batch only cover a limited part of the space of all allowable rows. FIG. 6 illustrates such a case: the task of the player is to guess three of eleven possible symbols A, B, C, D, E, F, G, H, I, J and K. There are 165 possible rows, of which the game organiser has decided that only 10 can be played with preprinted coupons. For selecting these 10 rows, the coupon identifiers or addresses from 0001 to 1010 are first shuffled by applying RP(address, 10, seed1) where seed1 is a constant seed number. Thus a randomly permutated ordinal number between 1 and 10 becomes associated with each coupon identifier. In order to randomly expand into all 165 possible rows (which themselves can be systematically generated in order as “A B C”, “A B D”, “A B E” etc.) the RP function is applied anew for each of said ordinal number between 1 and 10, this time as RP(ordinal_number, 165, seed2) where we assume, for the sake of generality, that some other constant seed number seed2 is used, although it could as well be seed1.

All in all, the process that associates a certain row with for example coupon identifier 0110 may be written as
RP(RP(0110,10, seed1), 165, seed2)=RP(3, 165, seed2)=50
so that the row associated with coupon identifier 0110 is “B C H”, because this is the 50th row in the list of systematically generated rows.

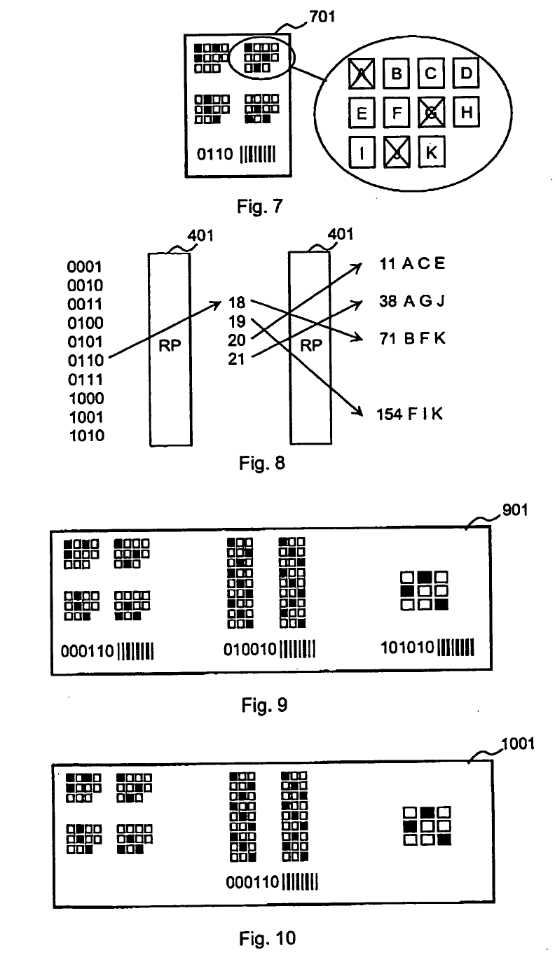

Actually it is not necessary to use the RP function twice, if the only goal is to expand from a limited space of coupon identifiers into the whole space of allowable rows. One could simply use RP(address, 165, seed) in the first place. However, applying a random permutator more than once becomes very advantageous if one considers associating a number of apparently randomly selected rows with a single coupon identifier. FIG. 7 illustrates an exemplary coupon 701, which carries a single identifier “0110” written in both cleartext form and machine-readable (barcode) form, and four gaming rows for a certain game of chance.

FIG. 8 illustrates an exemplary way of producing multiple-row coupons like the one in FIG. 7. The game is assumed to be the same as in the case of FIG. 6, i.e. the player guesses three symbols out of eleven (A, B, C, D, E, F, G, H, I, J, K). Addresses from 0001 to the maximum number of preprinted coupons (here binary 1010, i.e. 10 in the decimal system) are used as coupon identifiers, as is illustrated in the left-hand column. Starting from a coupon identifier, there is first used the RP random permutator to obtain a random auxiliary number between 1 and the maximum number of rows (here 165). In the exemplary case of FIG. 8,
RP(0110, 165, seed1)=18

In order to generate N rows for the coupon, we take this number and n−1 immediately following auxiliary numbers. In the exemplary case of FIG. 8, N=4 and we take 18, 19, 20 and 21. For each of these auxiliary numbers we use the RP random permutator again to obtain four ordinal numbers pointing to the list of systematically generated rows. The same seed is used for all four selections—this seed may be the same as seed1 above or a different seed. For the sake of generality we designate the seed used in this latter step as seed2, and observe how in the exemplary case of FIG. 8,
RP(18, 165, seed2)=71→B F K
RP(19, 165, seed2)=154→F I K
RP(20, 165, seed2)=11→A C E
RP(21, 165, seed2)=38→A G J

As a trivial alternative, expanding the obtained auxiliary numbers into a group of auxiliary numbers could naturally be made in some other systematical way than just taking the immediately following numbers. Starting from 18 one could take 17, 16 and 15; or 20, 22 and 24; or use any other systematic selection strategy. If the first auxiliary number happened to be very close to the limit of the available number range, the systematic selection strategy should involve so-called wrapping around: e.g. starting from 164 and using the “immediately following” selection strategy one should select 164, 165, 1 and 2.

Basically it would be possible to obtain the orginal numbers of four randomly selected rows directly from a coupon identifier simply by using four different seeds. However, such a solution involves a small but finite possibility of getting two identical rows, which would be unacceptable: if a player pays for N rows, he must receive N different rows. Additionally initialising a RP function with a seed may consume a not insignificant amount of processing capacity, so it is most advantageous if only a very limited number of different seeds, preferably only one, can be used. Another alternative would be to only allocate coupon identifiers N numbers apart, so that with N=4 the next coupon identifier after e.g. 0110 would be 1010, and print the rows obtained as RP(0110, 165, seed1), RP(0111, 165, seed1), RP(1000, 165, seed1) and RP(1001, 165, seed1) to the coupon carrying the identifier 0110. This alternative involves the drawback that it uses inefficiently the possible number space that can be used for identifiers.

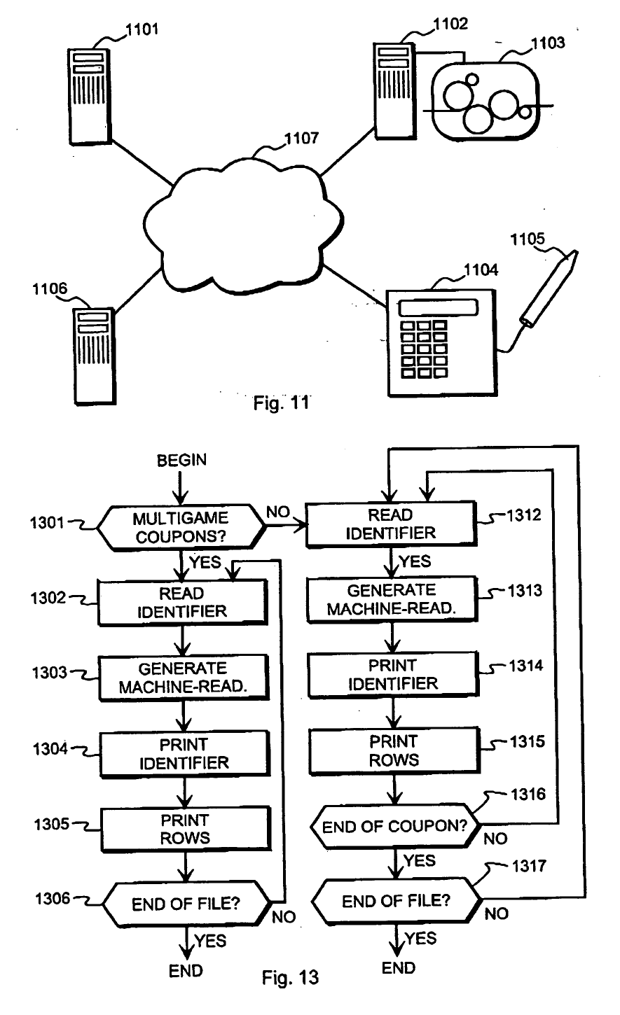

FIGS. 9 and 10 illustrate two possible ways of combining several games to a single coupon. The first, most straightforward alternative is to simply print the contents of three different coupons onto a single piece of paper (or other carrier material), resulting in the coupon 901 of FIG. 9. Each game on the combined coupon has an identifier of its own, so that the games can be played just as if the player purchased three separate coupons: the selling agent must use an electronic cash terminal to read or key in the identifiers of all those games in which the player wishes to participate. Also the generation of rows for the different games has been accomplished as three different, parallelly executed processes.

Most advantageously the game-specific identifier includes a game ID field: a symbol or a group of symbols in the identifier are used to denote, which game the identifier relates to. Another part of the identifier includes the so-called address, which is the starting point for generating the row(s) like the address “0110” in the examples above. The identifier may also include other fields, including but not being limited to

a validity field used to indicate a time period during which that particular preprinted coupon can be used to play that particular game

a “lucky number” which is an additional random number with which the player participates in the drawing of a bonus prize

a price field indicating the unit price to be paid for activating, i.e. playing, that game-specific part of the coupon

a row number field used to indicate, how many rows are preprinted on the coupon,

a game subgenus identifier, used e.g. in broadly defined betting games to specify the type of event that is the subject of betting at that particular time

a verification field used for one or more verification symbols derived from the contents of other parts in the identifier with a secret algorithm, in order to enable detecting fraud and errors.

In FIG. 10 there is only one identifier for the whole coupon. Obviously this brings about a first implication, according to which the coupon constitutes an all-at-once type gaming entity: reading or keying in the coupon identifier by the selling agent means that the player pays for and takes part in all games simultaneously. How the different rows for the different games can be generated, both at the coupon printing stage and at the activation stage after reading or keying in the coupon identifier, by using the single coupon identifier is discussed in the following.

As a general assumption each game involves a different number of guesses from a symbol space of different size. Despite of this, for each game the list of all possible rows can be systematically generated, as was described earlier, and even for each game any m:th row can be derived from a mathematical formula specific to that game, where m is between 1 and the total number M of possible rows. In the case of three different games like in FIG. 10, there are M₁ possible rows for the first game, M₂ possible rows for the second game and M₃ possible rows for the third game. The combined coupon includes N₁ preprinted rows for the first game, N₂ preprinted rows for the second game and N₃ preprinted rows for the third game (in FIG. 10, N₁32 4, N₂=2 and N₃=1). Selecting the rows to be printed on a coupon is thus the same as the task of randomly picking N₁ ordinal numbers from M₁, N₂ ordinal numbers from M₂ and N₃ ordinal numbers from M₃, using the coupon identifier as a starting point so that later the same ordinal numbers can be regenerated after reading the coupon identifier.

Since the operation of a random permutator function depends heavily on the number of symbols to be permutated, and since in general the dimension parameters M₁, M₂ and M₃ are all different, as a most straightforward solution we may take for each game
RP(RP(address, Mᵢ, seed1), Mᵢ, seed1)=ordinal_number 1ᵢ
RP(RP(address, Mᵢ, seed1)+1, Mᵢ, seed1)=ordinal_number 2ᵢ
RP(RP(address, Mᵢ, seed1)+(Nᵢ−1), Mᵢ, seed1)=ordinal_number Nᵢ
where i=1, 2, 3 refers to the first, second or third game respectively. Again, it is possible but not necessary to use a different seed in the “outer” occurrence of applying the RP random permutator function. In order to add randomness in a case where the dimension parameter M could be the same for two games, we may alternatively take into use game-specific seeds:
RP(RP(address, Mᵢ, seedᵢ), Mᵢ, seed1)=ordinal_number 1ᵢ
RP(RP(address, Mᵢ, seedᵢ)+1, Mᵢ, seedᵢ)=ordinal_number 2ᵢ
RP(RP(address, Mᵢ, seedᵢ)+(Nᵢ−1), Mᵢ, seedᵢ)=ordinal_number Nᵢ
or even
RP(RP(address, Mᵢ, seedᵢ₁), Mᵢ, seedᵢ₂)=ordinal_number 1ᵢ
RP(RP(address, Mᵢ, seedᵢ₁)+1, Mᵢ, seedᵢ₂)=ordinal_number 2ᵢ
RP(RP(address, Mᵢ, seedᵢ₁)+(Nᵢ−1), Mᵢ, seedᵢ₂)=ordinal_number Nᵢ

Also in the case of using a single, coupon-specific identifier it is advantageous to include into the identifier a “game ID” field the value of which indicates this time that a multigame coupon is in question. Additional fields can be used, similarly as has been described earlier in the case of game-specific identifiers.

Cross breeding is possible between the embodiment of FIG. 9, relying on game-specific identifiers, and the embodiment of FIG. 10, based on coupon-specific identifiers. A coupon could contain a “subcoupon-specific” identifier, the reading or keying in of which by the selling agent would indicate playing the games of only a certain part of the coupon, while for playing some other game preprinted on the same coupon but not included in said part would necessitate reading or keying in a different identifier related to that game only (or related to a different part of the same coupon). The coupon-specific and game-specific identifiers may even be alternative to each other on the coupon, so that the player will have the choice of either playing only a subset of the games on the coupon by making the selling agent read or key in the game-specific identifier(s) of the selected games, or play all games of the whole coupon at once by making the selling agent read or key in just the coupon-specific identifier.

We will conclude by describing certain aspects of a system according to an embodiment of the invention, as well as its method of operation. FIG. 11 illustrates a system comprising a game generator computer 1101, a printing controller computer 1102, a printing machine 1103 controlled by said printing controller computer 1102, an electronic cash terminal 1104 equipped with an automatic reading device 1105 and a gaming computer 1106. The computers 1101, 1102 and 1106 as well as the electronic cash terminal 1104 are linked together with communication connections, generally illustrated in FIG. 11 as the network 1107. In the following we assume that the system will operate according to the principle of FIG. 2, i.e. so that all generating and regenerating of rows will take place under the direct control of the game organiser, who also controls the game generator computer 1101. In an alternative embodiment, in which the electronic cash terminal 1104 would generate the rows from read coupon identifiers, we may say that the gaming computer 1106 is a divided functionality so that a row-generating part of it is located in the electronic cash terminal 1104.

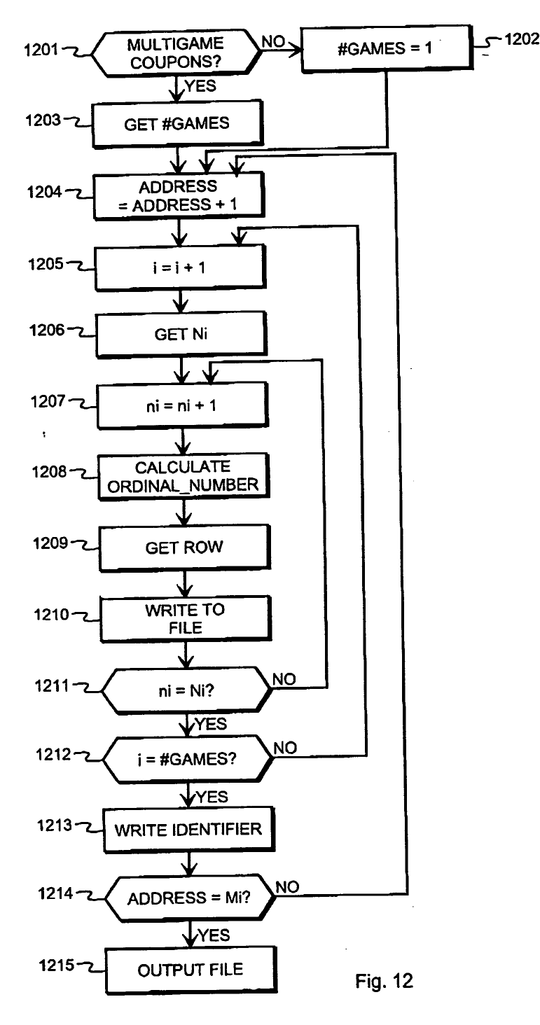

FIG. 12 illustrates a method of operation to be executed at the game generator computer 1101. At step 1201 it is decided, whether multigame coupons will be produced or not. Here a multigame coupon means a preprinted coupon having a single coupon identifier but more than one games on it. A negative decision at step 1201 means that the number of games to be included in a coupon is set to 1 at step 1202, otherwise the number of games to be included in a coupon is received at step 1203. We assume that all numerical parameters have been initialised to zero, so the first time of executing steps 1204 and 1205 sets numerical parameters ADDRESS and i to 1. ADDRESS is the part of a coupon identifier that will be used for deriving the rows to be printed on the corresponding coupon. The indexing parameter i is the number of the game to be currently considered.

At step 1206 there is read the number Ni of rows to be generated for the current game. At step 1207 another indexing parameter ni is increased by one to indicate which row (1st, 2nd, etc.) is being generated for the i:th game. At steps 1208 and 1209 the game generator computer uses the ADDRESS parameter and some of the methods described earlier to obtain a row, which it writes to a file at step 1210. If not all rows have been generated for the current game, there occurs a return from step 1211 to step 1207. If not all games for the current coupon have been dealt with, there occurs a return from step 1212 to step 1205; otherwise the coupon identifier is written to the file at step 1213. If the whole address space has not been gone through, there occurs a return from step 1214 to step 1204. Only after a positive finding at all of steps 1211, 1212 and 1214 the output file is released at step 1215.

FIG. 13 illustrates schematically a method to be executed at the printing controller computer 1102. At step 1301 it checks, whether multigame coupons are to be printed, a multigame coupon being one where a single, coupon-specific identifier is used to generate the gaming rows for more than one game. If multigame coupons are not in question, there will be either a separate file for printing the coupon parts relating to each game or a single file with a number or rows for each coupon, for example four rows for a three-game coupon so that one row is for the coupon itself and each one of the remaining three rows is for a different game on the coupon. In FIG. 13 we assume that the last-mentioned alternative (single file with a number or rows for each coupon) is used.

At step 1302 in the multigame coupon alternative there is read one coupon identifier; correspondingly at step 1312 there is read a first identifier related to a coupon. At steps 1303 and 1313 the appropriate identifiers are converted into machine-readable form, like bar code of the type Code 128 interpretation C. Steps 1304 and 1314 correspond to printing the identifiers. At steps 1305 and 1315 respectively the gaming rows are read from the input file and printed onto the coupon. If there are still identifiers unused in the input file, there occurs a return from step 1306 to step 1302 in the multigame coupon alternative. In the non-multigame alternative of FIG. 13 a return from step 1316 to step 1312 occurs, if there are still identifiers unused in the input file for the currently printed coupon. After a coupon has been completed, a return from step 1317 to step 1312 occurs for beginning the printing of the next coupon. After the input file(s) has/have been exhausted, the process ends.

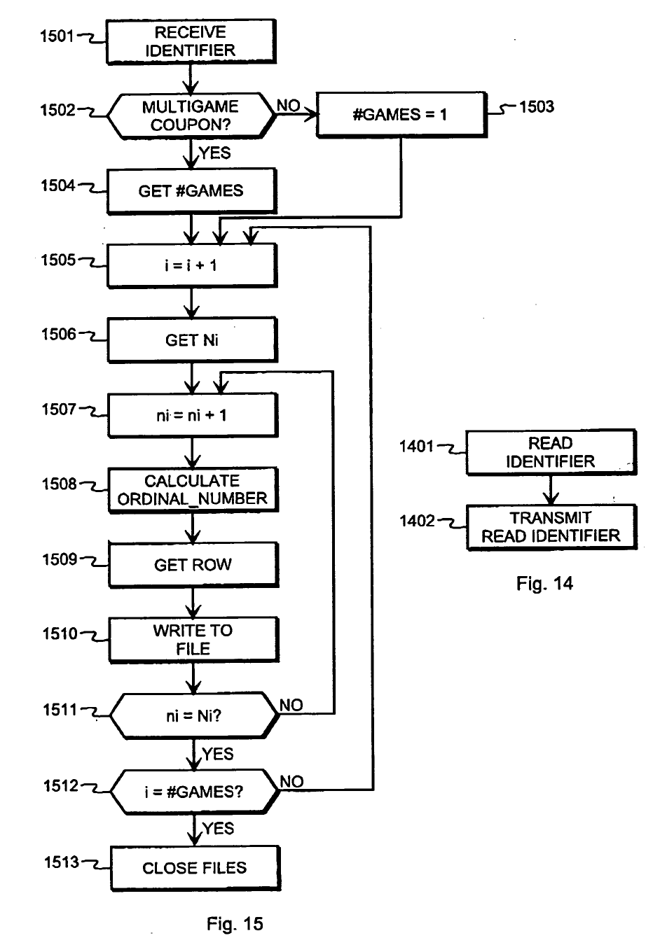

According to FIG. 14, the electronic cash terminal 1104 simply reads each identifier subjected to the automatic reading device 1105 at step 1401 and transmits the read identifiers to the game organiser at step 1402. As has been described earlier, there is the possibility that the electronic cash terminal executes after step 1401 a row-generating step, so that the transmission to the game organiser at step 1402 involves transmitting the generated row(s) and not just simply the read identifier.

FIG. 15 illustrates a method of operation of the gaming computer 1106, which is under the supervision of the game organiser. After having received a coupon identifier from an electronic cash terminal at step 1501, it checks at step 1502 whether the identifier corresponds to a multigame coupon. If not, the number of games parameter is set to 1 at step 1503, otherwise the appropriate number of games found on multigame coupons of this kind is read at step 1504. The loop between steps 1505 and 1512 corresponds to going through all games on the coupon, while the loop between steps 1507 and 1511 corresponds to going to all rows for a particular game in the coupon very much like the corresponding steps in the generation method of FIG. 12. For each row the address part of the coupon identifier is used in steps 1508 and 1509 to calculate the appropriate row, which is written into a file of played rows at step 1510. The number of rows to be found for a current game has been obtained at step 1506. After all rows for all games on the coupon have been regenerated and written to the appropriate files, the files are closed at step 1513.

Writing a row into a file of played rows at the game organiser's computer usually does not need to exclude playing the same row again for example by another player, although this may depend on the nature of the game to be played. In many cases it may be desirable to even allow the same player to play a the same row again, for example if the player has paid a higher price that entitles him to have multiple chances in the game. If an identifier is coupon-specific or at least includes a coupon-specific part, which is brought to the attention of the game organiser, it is possible for the game organiser to use the coupon-specific part for marking a coupon as played. This possibility is useful if the game involves a rule according to which each coupon can only be played once.

If the generation of rows at the coupon printing stage is transferred to the printing house as in FIG. 3, steps 1204 to 1214 of FIG. 12 are to be placed between steps 1305 and 1307 in FIG. 3 so that the intermediate printing step 1306 comes between steps 1212 and 1214. If the regeneration of rows of played coupons is transferred to the selling agent's electronic cash terminal as in FIG. 3, steps 1502 to 1512 take place of step 1402 in FIG. 14, followed by a step of transmitting all regenerated rows to the game organiser. As mentioned already earlier, in the last-mentioned case it may be said that the gaming computer functionality is distributed at least partly to the electronic cash terminal.

What is claimed is:

1. A method for using preprinted coupons in a game, comprising:
reading a coupon identifier from a coupon that also contains a preprinted gaming row,
on the basis of the coupon identifier, informing a gaming system about the playing of the gaming row, and
deriving the contents of the gaming row from the coupon identifier read from the coupon by using at least a part of the coupon identifier as input information to a random permutator that maps input information to a list of possible gaming rows.

2. A method according to claim 1, wherein reading the coupon identifier comprises using an electronic device to read a machine-readable coupon identifier that also appears on the coupon in human-readable form.

3. A method according to claim 1, wherein deriving the contents of the gaming row from the coupon identifier comprises:
utilising at least a part of the coupon identifier as an address input to a random permutator,
obtaining an output of the random permutator and
obtaining a gaming row by using the obtained output of the random permutator as an ordinal number referring to a location on an organised list of gaming rows.

4. A method according to claim 3, additionally comprising:
using a number of possible gaming rows as a set size input to the random permutator, and
using a seed number as a seed input to the random permutator.

5. A method according to claim 1, wherein deriving the contents of the gaming row from the coupon identifier comprises:
utilising at least a part of the coupon identifier as an address input to a first random permutator,
obtaining an output of the first random permutator,
using said output of the first random permutator as an address input to a second random permutator,
obtaining an output of the second random permutator and
obtaining a gaming row by using the obtained output of the second random permutator as an ordinal number referring to a location on an organised list of gaming rows.

6. A method according to claim 5, additionally comprising:
using a number of possible gaming rows as a set size input to the first random permutator,
using a seed number as a seed input to the first random permutator,
using a number of possible gaming rows as a set size input to the second random permutator, and
using a seed number as a seed input to the second random permutator.

7. A method according to claim 5, wherein in order to derive the contents of a number of gaming rows from the coupon identifier read from the coupon the method comprises:
utilising at least a part of the coupon identifier as an address input to a first random permutator,
obtaining an output of the first random permutator,
systematically expanding the obtained output of the first random permutator to a group of auxiliary numbers,
using each of said auxiliary numbers in turn as an address input to a second random permutator,
obtaining, for each used auxiliary number, an output of the second random permutator and
obtaining gaming rows by using the obtained outputs of the second random permutator as ordinal numbers referring to locations on an organised list of gaming rows.

8. A method according to claim 1, wherein in order to derive the contents of gaming rows for more then one game from the coupon identifier read from the coupon the method comprises:
using at least a part of the coupon identifier as input information to a first random permutator that maps input information to a list of possible gaming rows of a first game and
using at least a part of the coupon identifier as input information to a second random permutator that maps input information to a list of possible gaming rows of a second game.

9. A method according to claim 8, wherein the first random permutator and the second random permutator are differently initialised occurrences of the same random permutator.

10. A method according to claim 1, comprising:
reading the coupon identifier from the coupon at a location in a distributed domain,
informing a game organiser's system in a centralised domain about at least a part of the read coupon identifier and
deriving the contents of the gaming row from the coupon identifier at said game organiser's system in said centralised domain.

11. A method according to claim 1, comprising:
reading the coupon identifier from the coupon at a location in a distributed domain,
deriving the contents of the gaming row from the coupon identifier at said location in said distributed domain and
informing a game organiser's system in a centralised domain about the derived contents of the gaming row.

12. A method according to claim 11, wherein said game organiser's system is informed about the derived contents of the gaming row at a later instant of time, and said game organiser's system is informed also about a moment of time at which the coupon identifier was read from the coupon.

13. A method according to claim 1, wherein for creating the preprinted coupons the method comprises:
generating a coupon identifier,
utilising at least a part of the generated coupon identifier as an address input to a random permutator,
obtaining an output of the random permutator,
obtaining a gaming row by using the obtained output of the random permutator as an ordinal number referring to a location on an organised list of gaming rows,
printing the generated coupon identifier and the selected gaming row on a coupon and
repeating the steps above until a desired number of coupons have been printed.

14. A method according to claim 13, comprising:
generating a number of coupon identifiers at a game organiser's system,
transmitting the created coupon identifiers from the game organiser's system to a printing house and
at said printing house, deriving the contents of gaming rows from the coupon identifiers and printing the gaming rows and coupon identifiers on coupons.

15. A method according to claim 13, comprising:
generating a number of coupon identifiers at a game organiser's system,
at said game organiser's system, deriving the contents of gaming rows from the coupon identifiers,
transmitting the coupon identifiers and derived contents of gaming rows from the game organiser's system to a printing house and
at said printing house, printing the gaming rows and coupon identifiers on coupons.

16. A system for using preprinted coupons in a game, comprising an electronic terminal and a gaming computer, of which
the electronic terminal is adapted to receive a coupon identifier of a preprinted coupon and to communicate the coupon identifier to the gaming computer, and
the gaming computer is adapted to store information about the playing of a gaming row on the basis of the coupon identifier received from the electronic terminal;
wherein the gaming computer is adapted to derive the contents of the gaming row from the coupon identifier by using at least a part of the coupon identifier as input information to a random permutator that maps input information to a list of possible gaming rows.

17. A system according to claim 16, wherein the gaming computer is located in a centralised domain, and the electronic terminal is located in a distributed domain and adapted to communicate the coupon identifier to the gaming computer over a long-distance communication connection.

18. A system according to claim 16, wherein:
the electronic terminal is located in a distributed domain,
the gaming computer is a divided functionality, a part of which is located in the distributed domain and another part of which is located in a centralised domain,
the electronic terminal is adapted to communicate the coupon identifier to the part of the gaming computer located in the distributed domain locally,
the part of the gaming computer located in the distributed domain is adapted to derive the contents of the gaming row from the coupon identifier and
the part of the gaming computer located in the distributed domain is adapted to communicate the derived contents of the gaming row to the part of the gaming computer located in the centralised domain.

19. A system according to claim 16, wherein in order to create a number of preprinted coupons the system is adapted to
generate a coupon identifier,
utilise at least a part of the generated coupon identifier as an address input to a random permutator,
obtain an output of the random permutator, and
obtain a gaming row by using the obtained output of the random permutator as an ordinal number referring to a location on an organised list of gaming rows.

20. A system according to claim 19, wherein:
the system comprises a generating computer, a printing machine and a computer controlling the printing machine, and
the computer controlling the printing machine is adapted to receive coupon identifiers and corresponding gaming rows from the generating computer and to instruct the printing machine to print said coupon identifiers and gaming rows received from the generating computer.

21. A system according to claim 16, wherein:
the system comprises a generating computer, a printing machine and a computer controlling the printing machine,
the generating computer is adapted to generate coupon identifiers and to transmit generated coupon identifiers to the computer controlling the printing machine, and
the computer controlling the printing machine is adapted to
receive coupon identifiers from the generating computer,
utilise at least a part of a received coupon identifier as an address input to a random permutator,
obtain an output of the random permutator,
obtain a gaming row by using the obtained output of the random permutator as an ordinal number referring to a location on an organised list of gaming rows, and
instruct the printing machine to print said coupon identifier and said selected gaming row on a coupon.

22. A system according to claim 16, wherein:
the electronic terminal is adapted to receive a coupon identifier from a user, to display and electronic image of a preprinted coupon to said user and to communicate said coupon identifier to the gaming computer.
